(19) United States
(12) Patent Application Publication
(10) Pub. No.: US 2013/0179192 A1
(43) Pub. Date: Jul. 11, 2013

(54) Systems and Methods for Managing, Storing, and Exchanging Healthcare Information and Medical Images

(71) Applicant: GNAX Holdings, LLC, Atlanta, GA (US)

(72) Inventors: Janakan Rajendran, Roswell, GA (US); Mariano J. Maluf, Woodstock, GA (US); Jeff W. Hinkle, Marietta, GA (US)

(73) Assignee: GNAX HOLDINGS, LLC, Atlanta, GA (US)

(21) Appl. No.: 13/734,691

(22) Filed: Jan. 4, 2013

Related U.S. Application Data
(60) Provisional application No. 61/583,421, filed on Jan. 5, 2012.

(51) Int. Cl. G06F 19/00

(52) U.S. Cl. CPC G06F 19/322
USPC 705/3

(57) ABSTRACT

A system and methods for managing, securely storing, and exchanging patient information and medical images across a plurality of medical facilities and providers. A Universal Medical Information Archive System (“UMIAS”) allows medical providers in various physical locations to securely store and exchange patient information and medical images by providing a streamlined, unified, universal system. The UMIAS allows providers to request and view a particular patient's entire medical profile, which may include various medical images as well as myriad other items of medical information, from a centralized archive such as a cloud-based hosted archive system. Further, according to one embodiment, the UMIAS maintains a Universal Medical Patient Index, which collects and unifies local electronic patient information, and assigns each patient a particular a universal identifier, which is appended to all incoming medical images and can be used by all facilities to identify information relating to a given patient.

### CROSS REFERENCE TO RELATED APPLICATION

This application claims benefit under 35 U.S.C. §119(e) of U.S. Provisional Patent Application No. 61/583,421 filed Jan. 5, 2012, and entitled “Systems and Methods for Secure Health Information Exchange,” which is incorporated herein by reference as if set forth herein in its entirety.

### TECHNICAL FIELD

The present systems and methods relate generally to healthcare informatics as well as the storage, exchange, and analysis of healthcare information. More particularly, the present systems and methods relate to management, exchange, storage, and retrieval of patient information and medical images among multiple healthcare providers and across multiple platforms.

### BACKGROUND

Historically, medical providers (e.g., hospitals, doctors' offices, etc.) have utilized monolithic healthcare information technology solutions that typically address a single aspect of patient data. Furthermore, these healthcare information technology solutions are supplied and serviced by a variety of manufacturers and vendors, even within a single facility such as a hospital. For example, a hospital may have several practice groups, each having its own equipment for capturing medical images (e.g., MRI scanners, CT scanners, etc.). Generally, each piece of image-capturing equipment is paired with an individual picture archiving and communication system (“PACS”), and it is typical for a different manufacturer to provide each piece of equipment and each PACS. Likewise, individual practice groups outside of the hospital often have their own image-capturing equipment and PACS.

Generally, each PACS serves a single department or corresponding piece of equipment. Further, each PACS typically utilizes its own software, and formats and stores images in its own unique way, even within the same facility. Because of varying system architectures, there is an inherent lack of cohesion and connectivity between systems, which causes tremendous inefficiencies in sharing patients' medical images between practice groups, even within the same facility.

In an effort to integrate these disparate systems, facilities often utilize a vendor neutral archive (“VNA”). Generally, a VNA comprises a software module and database that is agnostic to the hardware and software of the various PACS's in a given facility, and thus provides centralized storage for medical images within the facility. Since a VNA generally utilizes a standard format and interface, in addition to centralized storage, the VNA typically allows for centralized storage and exchange of the medical images within the confines of a facility. According to one embodiment, such a VNA comprises the Acuo VNA provided by Acuo Technologies of Bloomington, Minn. The system is not, however, limited to the use of such a VNA.

While VNAs generally allow various PACS's within a facility to share information and images relating to a particular patient, attempting to share such information beyond the walls of a particular facility presents additional challenges. In addition to lack of cohesion and connectivity of the various PACS's, there are regulatory and compliance requirements that further complicate matters. Because of these challenges, images (and the work associated with creating them) are often duplicated, leading to increased and unnecessary storage and management costs, as well as additional costs to patients and potential risks to patients from increased radiation exposure. Traditional health information exchange (“HIE”) models have sought to remedy this issue. Generally, these HIE models are ecosystems or networks that seek to enable efficient and secure management, exchange, and utilization of information between healthcare providers, hospitals, patients and families, vendors, payers (e.g., insurance companies), and others.

These HIE models can be effective for exchanging general patient information, both within a facility and between facilities and practice groups, but the exchange of medical images presents additional challenges. The difficulties with exchanging medical images lay not only in system architecture (i.e., the actual interconnection of the various hospital and provider systems, as well as the difficulties in integration stemming from the proprietary nature of the systems), but also in the overall approach (i.e., silo-based vs. ecosystem-based). Specifically, in many cases, medical images (and patient information in general) is maintained in individual systems or databases at individual hospitals or various other medical provider offices. Typical HIE models utilized by such facilities generally are configured for one-to-one exchange of information. In other words, hospital A and hospital B are configured to exchange information. Likewise, hospital A and hospital C are similarly configured, as are hospitals B and C. The three hospitals are not, however, collectively configured to share information. Specifically, each hospital generally uses a unique format and protocol for managing, archiving, and utilizing medical images. These one-to-one configurations create a complicated, inefficient communications mesh, and easy, on-demand access to the images and information across multiple providers is virtually non-existent.

Further, the digital files of high resolution, digitized medical images, such as MRI scans and CT scans, are exceedingly large, thus requiring additional cost for storage and bandwidth for transfer or exchange. This can be a particularly significant issue for medical providers who need to view a patient's medical information remotely (i.e., when they are outside of their respective facilities and have no access to their on-site equipment). Finally, it can be a challenge to adhere to ever-changing regulatory and compliance requirements (e.g., encryption standards, etc.) within each specific facility.

Therefore, there is a long-felt but unresolved need for a system or method that is agnostic to the various system architectures and protocols of medical image capturing devices and allows for management and secure storage and exchange of patient information and patient medical images across a plurality of medical facilities and providers. Further, there is a need for a system or method that allows medical providers to remotely access and view a patient's medical information, particularly a patient's medical images.

### BRIEF SUMMARY OF THE DISCLOSURE

Briefly described, and according to one embodiment, aspects of the present disclosure generally relate to systems and methods for managing and securely storing and exchanging patient information and medical images across a plurality of medical facilities and providers.

According to one embodiment, a Universal Medical Information Archive System (“UMIAS”) allows various medical providers in various physical locations to securely store and exchange patient information and medical images. As used herein and as will be understood by one of ordinary skill in the art, “medical images” typically comprise not only the actual images, but also associated reports relating to the images, metadata, etc. According to one aspect, the storage and exchange is facilitated by use of a hosted, cloud-based, centralized environment. Instead of a complex mesh wherein, for example, a hospital has separate protocols and communications links in place for exchanging information and images with other hospitals and respective providers, who in turn have their own separate protocols and communications links in place for doing the same, the UMIAS provides a streamlined, unified, universal system. The UMIAS allows providers to request and view a particular patient's entire medical profile, which may include various medical images from various providers as well as myriad other items of medical information, from a centralized archive as opposed to requesting the information from each respective provider.

Further, according to one embodiment, the UMIAS maintains a Universal Medical Patient Index (“UMPI”), which collects and unifies local electronic patient information (“LEPI”) such as patient name, date of birth, Social Security number, etc., as well as any LEPI numbers or identifiers (i.e., provider-assigned patient identification numbers that serve to protect patient identity), thus facilitating patient information requests. Further still, according to one embodiment, the UMIAS assigns each patient a particular UMPI Number (or UMPI Identifier) that serves as a universal identifier for a particular patient, which is appended to all incoming medical images and can be used by all facilities to identify a information relating to a given patient, share medical images for given patients across facilities, and perform a host of other cloud-based or virtual functions.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is an exemplary environment in which an embodiment of the disclosed Universal Medical Information Archive System (“UMIAS”) is utilized.

FIG. 2A is an exemplary system architecture of one embodiment of the UMIAS.

FIG. 2B is an exemplary UMIAS database schema showing various exemplary data stored in a Universal Medical Patient Index (“UMPI”) table and a patient information table, according to one embodiment of the present disclosure.

FIG. 3 is a sequence diagram illustrating an image capture and storage process, according to one embodiment of the present disclosure.

FIG. 4 is a sequence diagram illustrating a remote medical image access process, according to one embodiment of the present disclosure.

FIG. 5 is a sequence diagram illustrating a local PACS image access process, according to one embodiment of the present disclosure.

FIG. 6 is an exemplary screen shot of a UMIAS computer interface dashboard, according to one embodiment of the present disclosure.

FIG. 7 is an exemplary screen shot of a UMIAS computer interface illustrating a patient lookup functionality, according to one embodiment of the present disclosure.

FIG. 8 is an exemplary screen shot of a UMIAS computer interface for matching potential patient matches to a UMIAS user's patient request, according to one embodiment of the present disclosure.

FIG. 9 is an exemplary screen shot of a UMIAS computer interface illustrating a patient request confirmation, according to one embodiment of the present disclosure.

FIG. 10 is an exemplary screen shot of a UMIAS computer interface illustrating the functionality of selecting from a plurality of patient medical images, according to one embodiment of the present disclosure.

FIG. 11 is an exemplary screen shot of a UMIAS computer interface for managing requests to a particular provider for patient medical images, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

### Overview

Aspects of the present disclosure generally relate to systems and methods for managing, securely storing, and exchanging patient information and medical images across a plurality of medical facilities and providers.

According to one embodiment, a Universal Medical Information Archive System (“UMIAS”) allows various medical providers in various physical locations to securely store and exchange patient information and medical images. Instead of a complex mesh wherein, for example, a hospital has separate protocols and communications links in place for exchanging information and images with other hospitals and respective providers, who in turn have their own separate protocols and communications links in place for doing the same, the UMIAS provides a streamlined, unified, universal system. The UMIAS allows providers to request and view a particular patient's entire medical profile, which may include various medical images from various providers as well as myriad other items of medical information, from a centralized archive as opposed to requesting the information from each respective provider. According to one aspect, the centralized archive is a cloud-based hosted archive system.

Further, according to one embodiment, the UMIAS maintains a Universal Medical Patient Index (“UMPI”), which collects and unifies local electronic patient information (“LEPI”) such as patient name, date of birth, Social Security number, etc., as well as any LEPI numbers or identifiers (i.e., provider-assigned patient identification numbers that serve to protect patient identity), thus facilitating patient information requests. Further still, according to one embodiment, the UMIAS assigns each patient a particular UMPI Number (or UMPI Identifier) that serves as a universal identifier for a particular patient, which is appended to all incoming medical images and can be used by all facilities to identify information relating to a given patient, share medical images for given patients across facilities, and perform a host of other cloud-based or virtual functions.

### Exemplary Embodiment

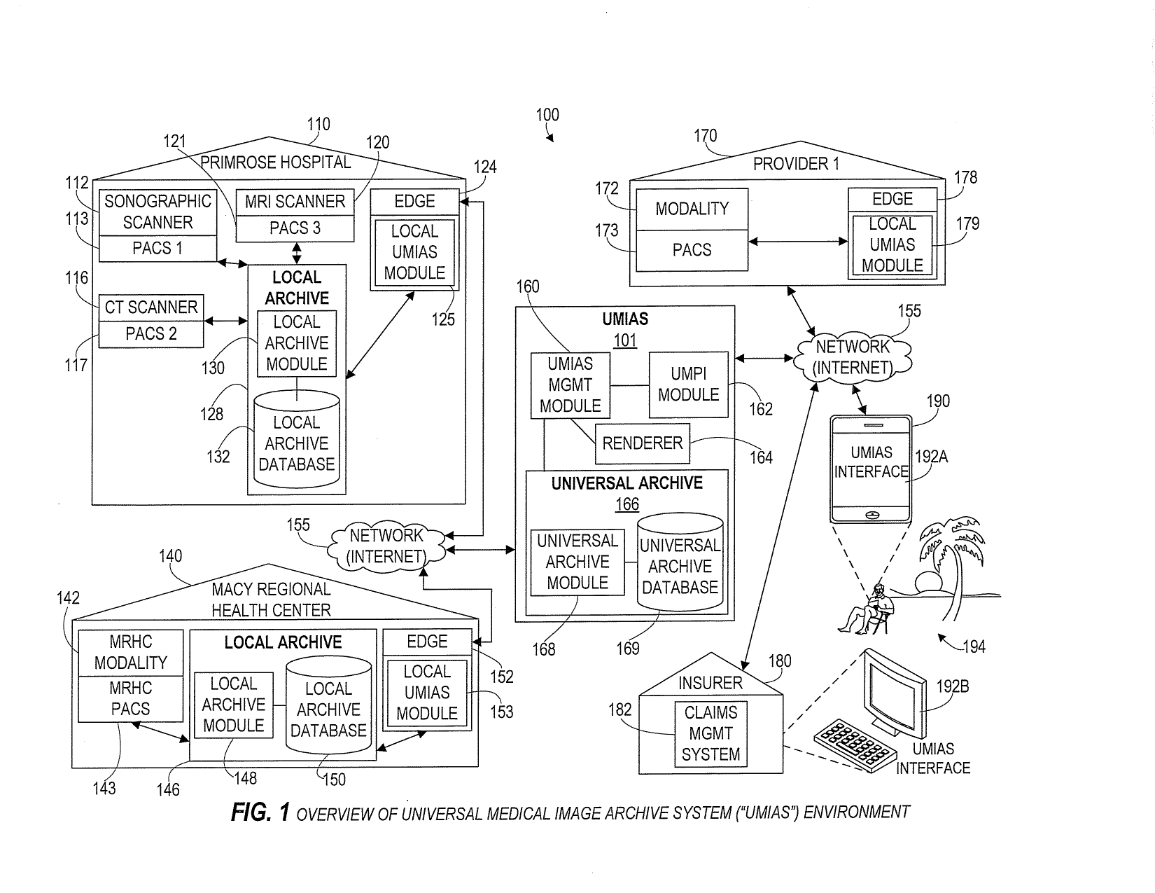

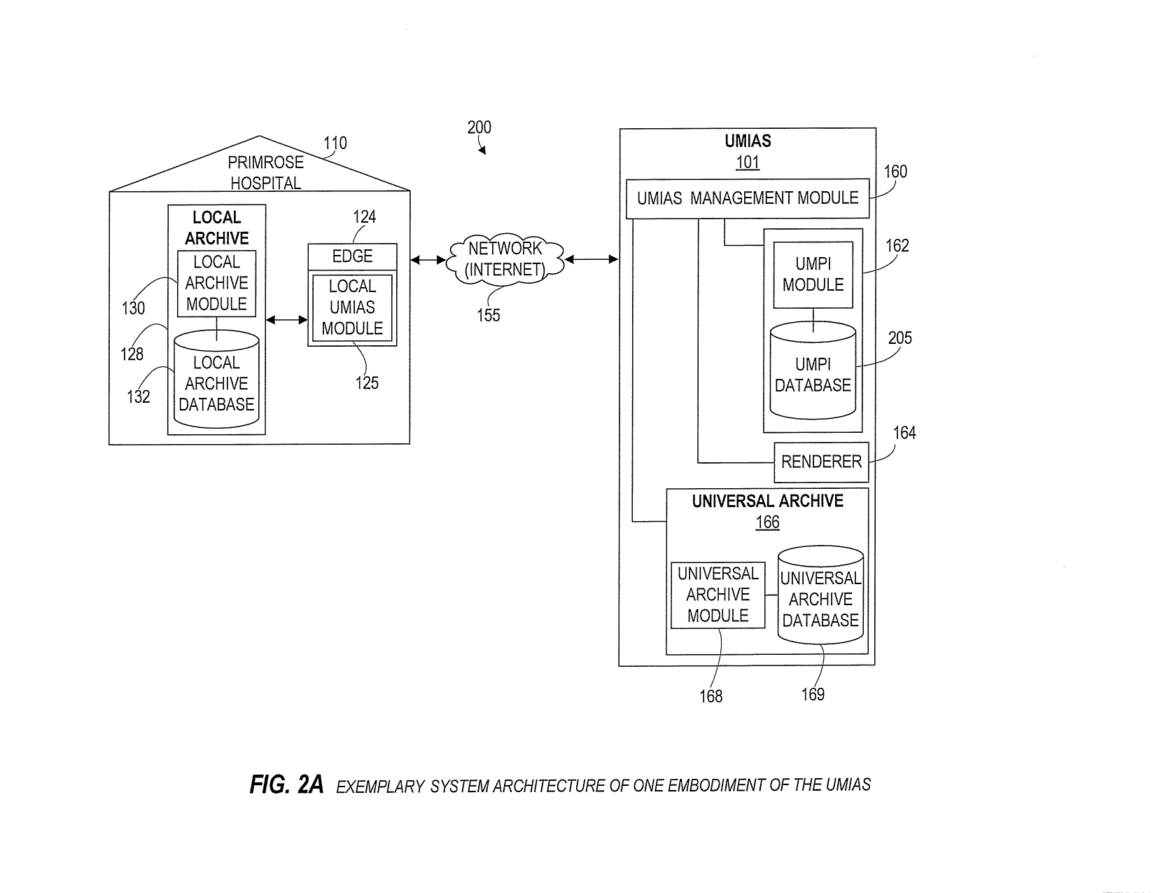

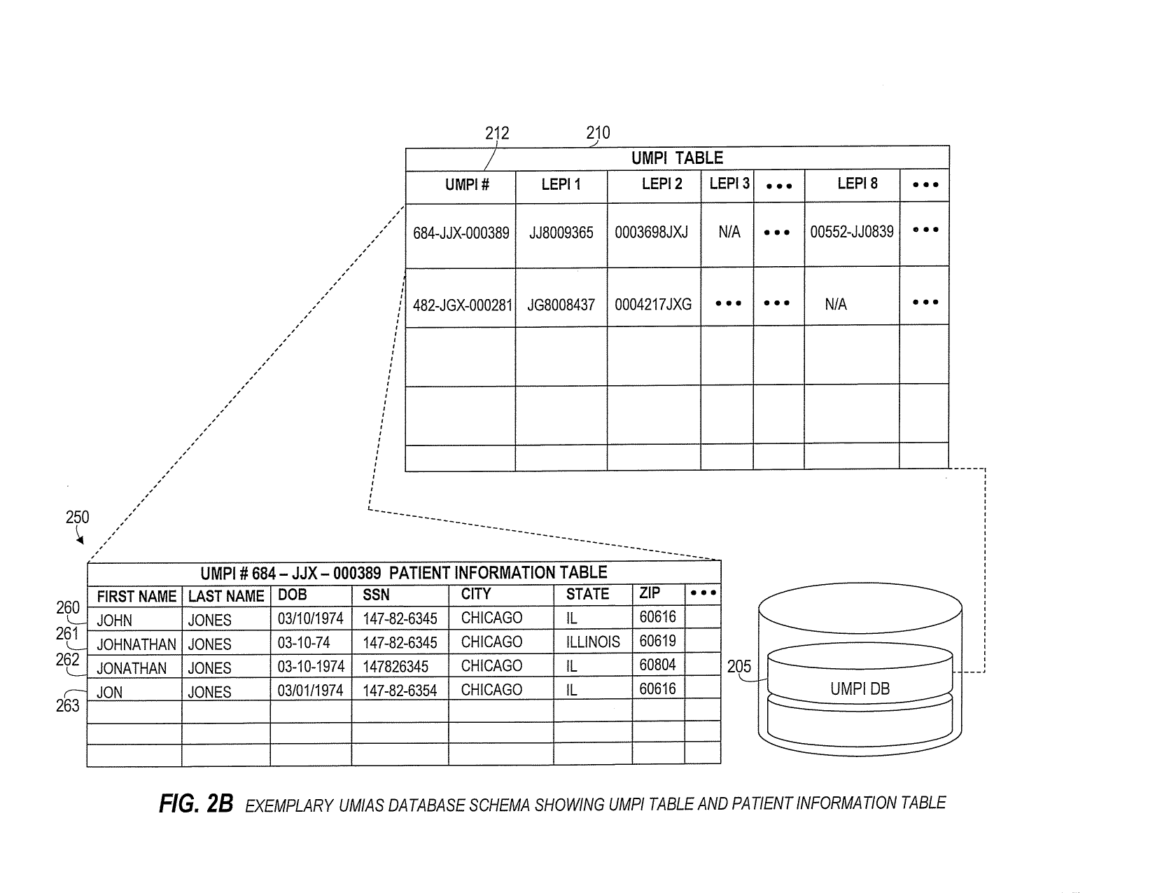

Referring now to the figures, FIG. 1 is an exemplary environment 100 in which an embodiment of the disclosed Universal Medical Information Archive System (“UMIAS”) 101 is utilized, constructed and operated in accordance with various aspects of the present disclosure. As shown in FIG. 1, the UMIAS 101 comprises a UMIAS management module 160 for carrying out various computer implemented processes of the UMIAS 101. The UMIAS 101 likewise includes a Universal Medical Patient Index (“UMPI”) module 162 for managing the UMPI. Embodiments of the UMIAS 101 also include a universal renderer 164 for rendering digital images, as will be understood by one of ordinary skill in the art. Embodiments of the UMIAS 101 also include a universal archive 166, which comprises a universal archive module 168 for carrying out various computer implemented processes of the universal archive 166, and a universal archive database 169 for storing medical images and other information utilized by the UMIAS 101. (Architectural details showing various software modules, engines, and databases comprising an embodiment of the UMIAS 101 will be described in greater detail in connection with FIG. 2.)

As shown in FIG. 1, the UMIAS 101 is in operative communication with Primrose Hospital 110, a hypothetical hospital facility. The UMIAS 101 and the hospital 110 are operatively connected through a network 155, such as the Internet. Typically, such operative connections involve a secure connection or communications protocol, and communications over a network 155 typically involve the use of one or more services such as a Web-deployed service with client/server architecture, or through a cloud-based system. As further shown in FIG. 1, the UMIAS 101 is in operative communication with Macy Regional Health Center (“MRHC”) 140 (a second hypothetical hospital facility or medical provider), an additional medical provider (“Provider 1”) 170 (e.g., a hypothetical doctor or doctor group), an insurer 180, and the mobile device 190 of a vacationing doctor/provider 194. (As will be understood, hospitals, medical systems, doctors, etc., referenced herein are generally referred to as “providers.”)

The hospital 110 shown in FIG. 1 includes three separate exemplary modalities (or types of medical imaging equipment): a sonographic scanner 112; a CT scanner (i.e., computed tomography scanner) 116; and an MRI scanner (i.e., medical resonance imaging scanner) 120. Generally, a particular modality is utilized for capturing a specific type of medical image. For example, an MRI scanner 120 may be used to take a detailed image of a human brain or perhaps a knee to determine if a patient requires surgery. As will be understood by one of ordinary skill in the art, the examples shown in FIG. 1 are not representative of all modalities, and a medical facility could have any number or type of modalities.

As shown in FIG. 1, each of the modalities 112, 116, and 120, are in operative communication with their respective PACS (i.e., picture archiving and communication system), PACS 1 113, PACS 2 117, and PACS 3 121, respectively. Generally, a PACS stores and provides access to images from a particular modality, typically via a workstation for interpreting and reviewing the images. As will be understood by one of ordinary skill in the art, each of the modalities may be maintained or provided by different companies, each with differing protocols, operating systems, image formats, and the like. Likewise, in general, a particular modality is configured to operate with a particular PACS so the medical images and information are configured and formatted in a manner specific to a specific modality/PACS pairing. The respective modalities and PACS's, however, are not configured to be integrated with each other as the software, data, formatting, etc., are often incompatible. Therefore, for example, while the MRI scanner 120 and PACS 3 121 are configured to communicate and exchange information, and the CT scanner 116 and PACS 2 117 are likewise configured to communicate and share information, the MRI scanner 120 and PACS 3 121 are not configured to communicate or exchange information with the CT scanner 116 or PACS 2 117.

While the various modalities within a particular facility are, in general, not configured to communicate or exchange information, the modalities are typically configured to communicate and exchange information with a local medical information archiving system (i.e., “vendor neutral archive” or “VNA”) implemented and configured specifically for the particular facility. As shown in FIG. 1, the local medical information archiving system (i.e., VNA) is represented by the local archive 128. According to the embodiment shown in FIG. 1, the local archive 128 comprises a local archive module 130 for carrying out various computer implemented processes of the local archive 128. The local archive 128 further comprises a local archive database 132 for storing patient information, medical images, and other information necessary for the operation of the local archive 128.

According to one embodiment, as noted previously, the local archive 128 serves as a vendor neutral archive capable of interfacing with the various modalities in a given facility. Because it is vendor agnostic, the local archive 128 is configured to communicate with each modality and respective PACS independently. This in turn allows, for example, the sonographic scanner 112 and PACS 1 113 to communicate and exchange information with the MRI scanner 120 and PACS 3 121, even though the individual modalities generally are not configured to communicate and exchange information with each other, as will be understood by one of ordinary skill in the art.

As shown in the embodiment illustrated by FIG. 1, an edge device 124 generally is located at each provider facility. An edge device 124 typically represents a general purpose computer, network attached component device, or other specific computing device or server that operates UMIAS software, is capable of being managed and/or controlled by the UMIAS 101, and generally includes an operative connection to one or more medical information archiving systems (e.g., 128). Network edge devices 124 generally are identified with several attributes, for example, a device identifier, a device type, a network address, a location, etc. Additionally, network edge devices 124 typically are self-contained, compact, energy-efficient nodes running proprietary UMIAS software. As noted above, the UMIAS 101 is in operative communication with the hospital 110 via a network 155. According to one embodiment, the edge device 124 manages the connectivity and communication and exchange of information between the hospital 110 and the UMIAS 101, via the network 155. According to one embodiment, the local edge device 124 includes a local UMIAS module 125 that carries out the various computer implemented processes of the edge device 124 and manages information to be shared between the hospital 110 and the UMIAS 101.

The environment shown in FIG. 1 also includes MRHC 140 and Provider 1 170, which are two additional hypothetical medical providers. As shown, MRHC 140 and Provider 1 170 are operatively connected to the UMIAS 101 via the network 155. Similar to the Primrose Hospital 110, MRHC 140 has a particular modality (MRHC Modality) 142 configured to communicate with a PACS 143. According to one embodiment, the modality 142 and PACS 143 are operatively connected to a local archive 146, which comprises a local archive module 148 for carrying our various computer implemented processes for the local archive 146, and a local archive database 150 for storing patient information, medical images (and their associated metadata, reports, etc.) captured by the modality 142, and other information necessary for operation of the local archive 146. Further, according to one embodiment, the local archive 146 is operatively connected to an edge device 152 operated by the UMIAS 101. As discussed above regarding the hospital 110, according to one embodiment, the edge device 152 manages the connectivity, communication, and exchange of information between MRHC 140 and the UMIAS 101, via the network 155. Likewise, according to the embodiment shown in FIG. 1, the edge device 152 comprises a local UMIAS module 153, which manages information to be shared between MRHC 140 and the UMIAS 101 in addition to carrying out the various computer implemented processes of the edge device 152.

As shown in FIG. 1, Provider 1 170 is similarly configured as MRHC 140 with one exception: according to the embodiment shown, the Provider 1 modality 172 and PACS 173 are in direct operative connection with the edge device 178, which comprises a local UMIAS module 179. As will be understood by one of ordinary skill in the art, when a provider offers only a single modality, it may not be necessary to utilize a VNA or local archive because the provider's facility generally is designed and configured to operate in conjunction with whichever modality it offers. Specifically, because only one vendor may supply the PACS for the given facility, there is no need to normalize information across multiple vendors.

Though each provider in the FIG. 1 embodiment is shown as utilizing an edge device (i.e., 124, 152, and 178), according to one embodiment, a local archive can be configured to communicate directly with the UMIAS 101. In such cases, a local edge device is unnecessary. For example, in the case of Primrose Hospital 110, the local archive module 130 would be in operative communication with the UMIAS 101 and would be capable of being managed and/or controlled by the UMIAS 101.

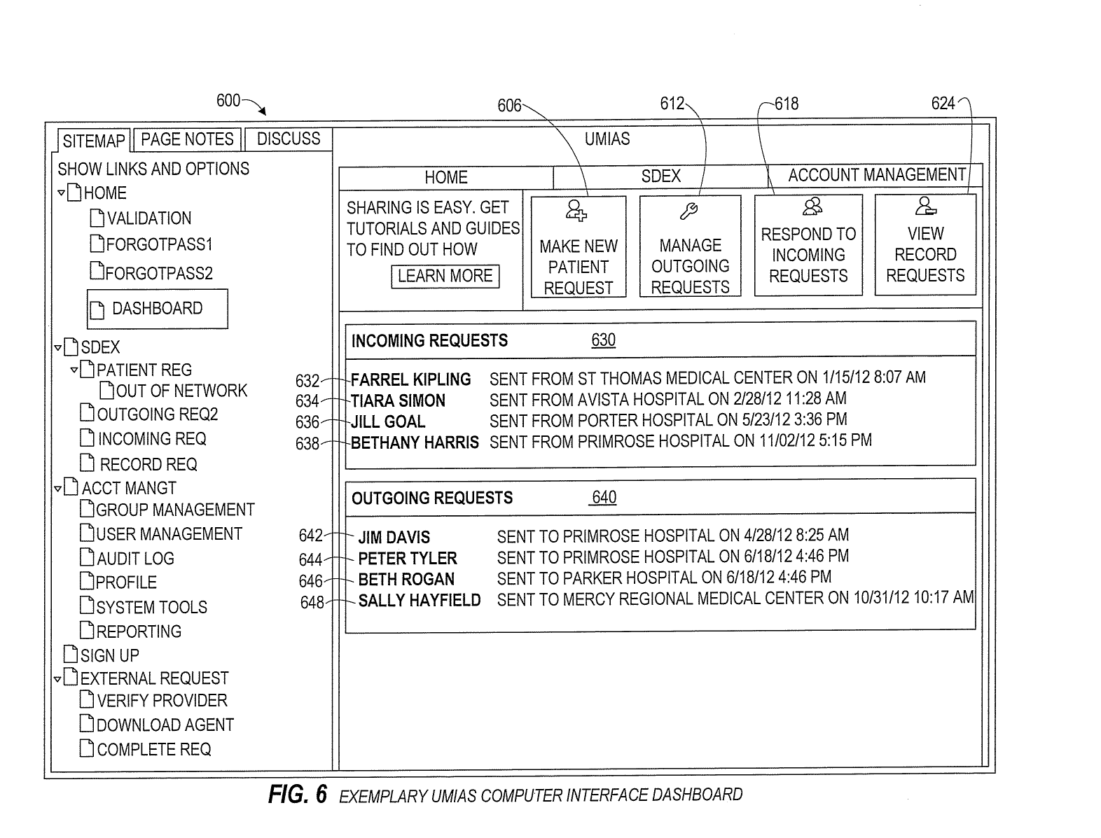

According to one embodiment, a mobile user is able to communicate directly with the UMIAS 101 via a mobile device (e.g., smart phone, laptop computer, tablet computer, etc.). As shown in the FIG. 1 embodiment, a vacationing doctor 194 is using a tablet computer 190, which is operatively connected to the network 155. As will be understood by one of ordinary skill in the art, the network 155 provides a wireless link between a UMIAS interface 192a running on the doctor's 194 tablet computer 190, which allows the remotely-working doctor 194 to access the UMIAS 101 to securely view patient information and medical images. (An exemplary embodiment of a UMIAS interface 192a, 192b will be discussed further in relation to FIGS. 6-11). As will be understood and appreciated, the ability to access and view patient information and medical images is advantageous as it allows doctors scheduling flexibility and mobility. Traditionally, in order to view patient images, it was necessary for doctors to access a local PACS (e.g., 117), which necessitated the doctor's presence at the medical facility. Since the presently disclosed embodiment allows providers to view medical images and information remotely, they are no longer tied to a particular facility.

Finally, the embodiment shown in FIG. 1 shows an insurer 180 with a claims management system 182 in operative communication with the UMIAS 101 via a network 155. According to one embodiment, an insurer utilizes a claims management computer system 182 to assist with managing, evaluating, adjusting, and adjudicating insurance claims, as will be understood by one of ordinary skill in the art. According to one aspect, in the course of handling such insurance claims, an insurance agent (or representative thereof) may require access to an insured's medical information and medical images, which may be stored in the UMIAS 101. According to one embodiment, in such cases, the insurance agent utilizes a UMIAS interface 192b to access such information.

Though not shown, according to certain embodiments, the UMIAS also may be accessed by a patient who wishes to view his/her own medical information or images. Similarly, a patient's family member or other representative may access the system to view the patient's information. According to one aspect, such access by any family member or other representative generally requires prior authorization from the patient.

As discussed, the presently disclosed embodiment allows providers in various locations to securely store and exchange patient information and medical images. As noted, traditional solutions are configured for one-to-one exchange of such information. In traditional systems, for example, when fictional patient John Jones visits three separate providers for treatment (e.g., Provider A, Provider B, Provider C), each provider typically creates and locally stores any medical information or images associated with Mr. Jones's treatment. In a traditional system, a fourth provider (e.g., Provider D) wishing to review Mr. Jones's treatment history would need to request files from Providers A, B, and C individually. With the presently disclosed embodiment, Provider D could access the UMIAS 101 and view Mr. Jones's entire treatment history from Providers A, B, and C, thus saving the time, effort, and resources involved in making the individual requests. If Mr. Jones needed emergency treatment, Provider D could access Mr. Jones's treatment history nearly instantaneously, and the information could be accessed remotely if necessary, thus allowing Provider D to provide faster, more thorough treatment.

According to one aspect, Provider D's quick access to Mr. Jones's treatment history is facilitated by a “break the glass” policy, which bypasses any patient- or provider-related consent requirements, as will be understood by one of ordinary skill in the art.

The discussions above in association with FIG. 1 are merely intended to provide an overview of an embodiment of the present systems and methods for managing, securely storing, and exchanging patient information and images across a plurality of medical facilities and providers. Accordingly, it will be understood that the descriptions in this disclosure are not intended to limit in any way the scope of the present disclosure. Various architectural details of an embodiment of the disclosed UMIAS will be described next in greater detail.

FIG. 2A illustrates an exemplary UMIAS architecture 200 according to one embodiment of the present disclosure. According to one aspect, the UMIAS 101 is hosted on a physical server, a cloud server, or a virtual server centrally hosted in the cloud. According to one embodiment (and as will be discussed further), the UMIAS 101 is a collection servers, databases, and software modules comprising processes, subroutines, or various algorithms operated by an embodiment of the UMIAS 101.

In the specific embodiment shown in FIGS. 1 and 2A, the UMIAS 101 includes a UMIAS management module 160, which carries out various computer implemented processes of the UMIAS 101 and manages the connections, communications, and exchanges of information between the collection of software modules and databases comprising the UMIAS 101.

As further shown in the FIG. 1 and FIG. 2A embodiments, the UMIAS 101 further comprises an UMPI module 162 for managing a proprietary Universal Medical Patient Index (i.e., UMPI), which is used to collect patient identifying information and generate a unique number or alpha-numeric character combination (i.e., “UMPI ID” or “UMPI Number”) that identifies each particular medical patient. A patient's UMPI Number serves as a universal, medical provider-agnostic means for identifying the particular patient. According to one embodiment, the UMPI module includes an UMPI database, which stores the UMPI and other associated information.

Typically, upon associating with a new patient, medical providers (e.g., 110, 140, 170) collect a plurality of types of patient identifying information. For example, a medical provider may request a patient's first and last name, date of birth, Social Security number, gender, medical history, etc. Generally, subsequent to collecting the patient identifying information, the medical provider will electronically store this information as local electronic patient information (“LEPI”). Further, in an effort to protect a medical patient's privacy, after collecting and storing the patient's LEPI, the provider generally assigns the patient a unique number or alpha-numeric identifier (i.e., “LEPI number”), which the provider uses to identify and refer to the patient within the scope of the provider's care.

While this practice of assigning LEPI numbers to patients is common among medical providers, each medical provider typically utilizes their own method for generating such LEPI numbers. For example, if fictional patient John Jones visits the (unshown) emergency room of Primrose Hospital 101, he may be assigned “JJ8009365” as his LEPI number. Supposing the Primrose Hospital 101 refers John Jones to MRHC 140 for follow-up treatment, MRHC 140 may assign John Jones its own unique LEPI number, for example, “0003698JXJ.” To further complicate matters, John Jones may return to the Primrose Hospital 101 for an MRI scan, and the department overseeing the MRI scanner 120 may assign him an additional LEPI number, e.g., “00552-JJ0839.”

According to one embodiment, the UMPI module 162 collects the various elements of patient identifying information collected by each of the medical providers (i.e., the LEPI) as well as the various LEPI numbers assigned by the providers. After collecting, collating, and storing the LEPI from the various providers and the various LEPI numbers for the particular patient as assigned by the providers, according to one embodiment, the UMPI module 162 subsequently generates and assigns an UMPI Number to each respective patient, thereby unifying a particular patient's various LEPI and LEPI numbers under one universal identifier.

FIG. 2B is an exemplary embodiment of an UMPI table 210 stored in an embodiment of a database 205 in an UMPI module 162. According to one embodiment, the UMPI table 210 comprises an UMPI Number column 212 for storing UMPI Numbers, which point to patient profiles associated with the respective UMPI Numbers. For example, UMPI Number 684-JJX-000389 points to the patient profile associated with fictional patient John Jones. Additionally, as shown in the FIG. 2B embodiment and as described above, each UMPI Number is associated with the various LEPI numbers attributed to a particular patient. In the FIG. 2B example, the UMPI Number for John Jones (i.e., 684-JJX-000389) is associated with various LEPI numbers received for John Jones, e.g., JJ8009365, 0003698JXJ, and 00552-JJ0839.

Additionally, according to one embodiment, the UMPI module 162 seeks to unify the various pieces of patient identifying information received from the various providers and create a patient profile for the respective patients. Returning to fictional patient John Jones, upon his initial visit the Primrose Hospital 101, as part of his LEPI, Mr. Jones's first name may be entered as “JOHN.” Then, when he visits MRHC 140, Mr. Jones may provide his full first name, upon which, as part of his LEPI for MRHC 140, his first name is entered as “JOHNATHAN.” Further, when Mr. Jones returns to the Primrose Hospital 101 for his MRI scan, as part of his LEPI, that department may incorrectly input his first name as “JONATHAN.” According to one embodiment, the UMPI module 162 seeks to unify this information such that a medical provider requesting information relating to JOHN JONES will receive the proper information regardless of whether the provider requests information for “JOHN,” “JOHNATHAN,” “JONATHAN,” or even “JON.”

In the above example and according to one embodiment, in order to unify the various pieces of patient identifying information (i.e., “JOHN,” “JOHNATHAN,” “JONATHAN,” “JON,” etc.) such that they all are associated with fictional patient John Jones, the UMPI module 162 performs a computer-implemented patient identification process. According to one embodiment, upon receipt of patient identifying information, the information is stored in a local database or local memory of the UMPI module 162. The UMPI module 162 then performs a predetermined patient identifying algorithm, which interprets the various pieces of patient identifying information (e.g., first name, last name, Social Security number, date of birth, etc.), and compares the received information to patient profiles previously stored in the UMPI module 162 to determine whether any currently stored patient profiles match the received patient identifying information (or individual pieces of the received patient identifying information). As used herein, patient profiles are electronic profiles representing a particular patient comprising various items of patient identifying information relating to the patient (e.g., first and last name, date of birth, address, etc.). Upon determining the received information matches currently stored information, the UMPI module 162 associates the received information to the matched, currently stored information. If the UMPI module 162 determines that no stored information matches the received information, according to one embodiment, the UMPI module 162 generates a new patient profile (and corresponding UMPI ID) to which it associates the received information.

As noted, FIG. 2B is an exemplary embodiment of an UMPI table 210 stored in an embodiment of a database 205 in an UMPI module 162. Also shown in FIG. 2B is a patient profile 250 for a patient having UMPI Number 684-JJX-000389 (i.e., John Jones). As shown, Mr. Jones's patient profile 250 includes four separate entry rows (i.e., 260, 261, 262, and 264), each representing patient identifying information received from a particular provider, according to one embodiment. Referring back to the patient identification process described above, the UMPI module 162 may receive, for example, the following patient identifying information: first name (JON); last name (JONES); DOB (03-10-74); SSN (147826345); state (Illinois). According to one embodiment, upon receipt of this information, the UMPI module 162 performs a patient identification process in which a patient identifying algorithm interprets and compares the received information to the patient profiles (e.g., 250) stored in the database. Not all of the received information matches the patient profile 250 fields as shown in FIG. 2B (i.e., no city or zip code were received, and the received first name “JON” matches only the first name as shown in patient profile row 263). Nevertheless, as the majority of the received information matches the patient profile 250 fields, according to one embodiment, the patient identifying algorithm interprets the received information as matching the patient profile 250 and associates the received information accordingly. According to one aspect, the patient identifying algorithm assigns greater weight to particular pieces of patient identifying information that are more permanent (e.g., Social Security number or date of birth). As will be understood and appreciated, such information generally is permanently associated to a patient unlike, for example, an address, which can change any time a patient changes residences.

The currently-disclosed embodiment of the UMIAS 101 likewise includes a renderer 164. As will be understood to one of ordinary skill in the art, in general, a renderer is a medical image viewer application, which processes electronic digital image files such that they can be viewed by a medical provider or other UMIAS user. According to one embodiment, the renderer 164 is provided by a third party. In one embodiment, a renderer comprises the eUnity renderer provided by Client Outlook, Inc., of Ontario, Canada.

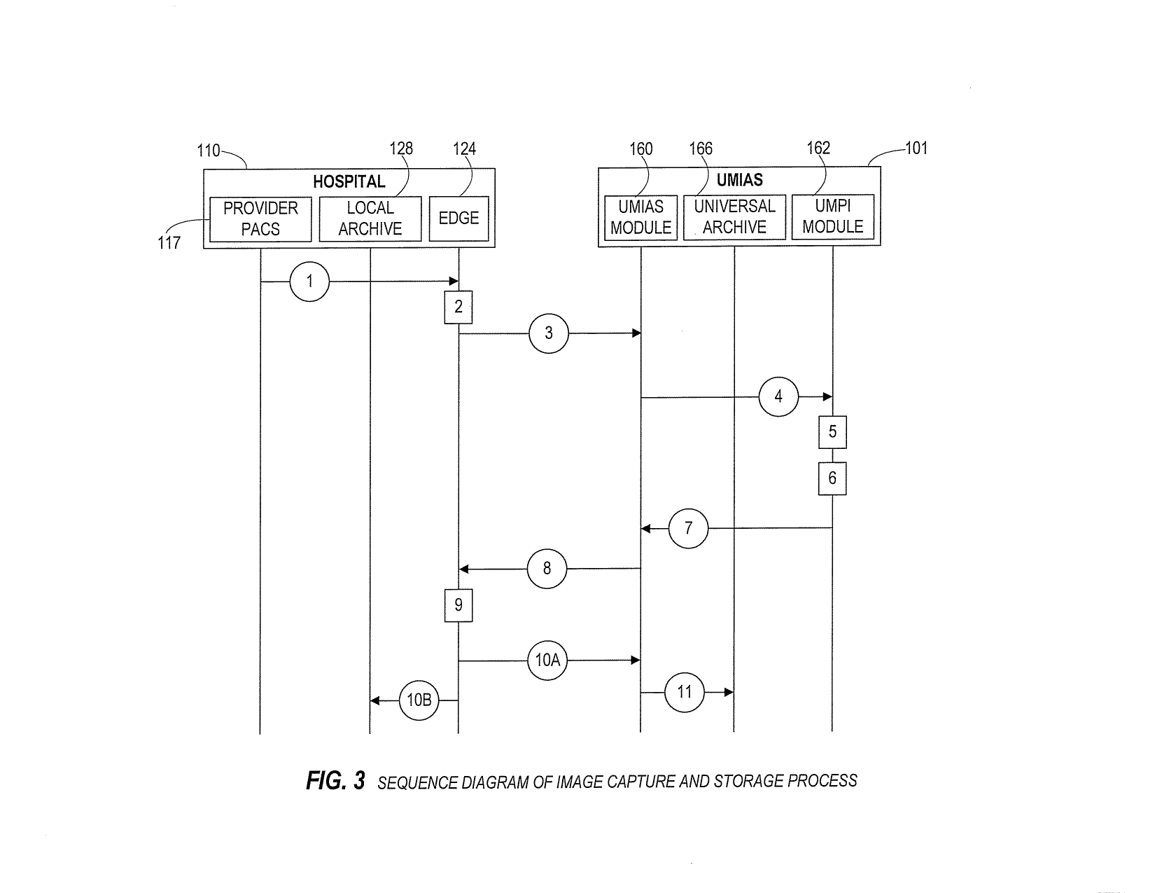

Referring again to FIG. 2A, the UMIAS 101 also includes a universal archive 166. According to one embodiment, the universal archive 166 provides hosted, cloud-based, centralized storage for medical information and digital files of medical images, which, as previously discussed, are typically very large and require substantial storage space. In one embodiment and as shown in FIG. 2A, a universal archive 166 comprises a universal archive module 168 for carrying out the various computer-implemented processes of the universal archive 166. According to one aspect, these processes include managing requests for patient images as will be discussed in relation to FIGS. 3-5. According to the present embodiment, the universal archive 166 also includes a universal archive database 169 for storing electronic medical images and various information related thereto (including the reports associated with the medical images). According to one aspect, the information related to the medical images can include a multitude of metadata, e.g., patient information, date and time the image was captured, the make and model of the modality that captured the image, and many other types of information. According to one aspect, there are Digital Imaging and Communications in Medicine (i.e., DICOM) tags associated with the images (or embedded into the image information). As will be understood by one of ordinary skill in the art, DICOM is a standard utilized for managing, storing, and transmitting medical imaging information. As will be understood and appreciated, according to one embodiment, the universal archive 166 and its respective components may be configured similar to a VNA, which may be provided by a third party (e.g., Acuo Technologies of Bloomington, Minn.). In other embodiments, Applicant may provide the universal archive's 166 necessary hardware and software. Further, according to one embodiment, aspects (or the entirety) of the universal archive can be replicated at a local archive (e.g., 128). Likewise, portions or the entirety of various local archives (e.g., 128, 146, etc.) can be replicated at the universal archive 166.

It will be understood and appreciated that the specific modules and databases as shown in FIG. 2A are for illustrative purposes only, and embodiments of the present system are not limited to the specific architecture shown. In one alternate example, functionalities of the UMIAS management module 160, UMPI module 162, renderer 164, and universal archive 166 can be combined into a single or even multiple server modules, possibly with other functionalities as will occur to one of ordinary skill in the art. Further, various types of information can be stored in the databases in the enclosed embodiment, which are not limited to merely storing the information as described herein. In many scenarios, one or more servers can share the same data, as will occur to one of ordinary skill in the art.

Furthermore, as will be understood by one of ordinary skill in the art, data tables shown herein, such as the UMPI table 210 or the patient profile 250, are presented for illustrative purposes only, and embodiments of the present system are not limited to data, information, and fields in the specific data tables shown. Additionally, the UMIAS 101, in alternate embodiments, can comprise various other data tables (and databases), as will occur to one skilled in the art.

FIG. 3 is a sequence diagram illustrating an exemplary sequence of steps associated with an image capture and storage process, according to one embodiment of the present disclosure. In one embodiment, a medical provider, e.g., Primrose Hospital 110, captures a medical image and transmits the image to the UMIAS 101, which then associates Universal Medical Patient Index (“UMPI”) information to the image and ultimately stores the image or returns the image to the provider for local storage, according to one embodiment. According to the embodiment shown in FIG. 3, after a medical image is captured by a particular modality (e.g., CT scanner 116), and after the respective PACS (e.g., PACS 2 117) associates the relevant metadata (LEPI and image information) to the image, starting at step 301, the respective PACS transmits the image and associated patient information (i.e., LEPI) and image information to the provider's edge device (e.g., 124). In one embodiment, the provider's edge device (e.g., 124) queries the respective PACS (e.g., 117) for new images and associated information at predetermined intervals, and then receives the images and associated information according to predetermined criteria (e.g., the elapsed time since the image was capture, etc.). In the FIG. 3 embodiment, at step 302, the local UMIAS module 125 of the edge device 124 extracts the LEPI associated with the image. According to one aspect, the local UMIAS module 125 reads the LEPI from the DICOM tag(s) associated with the image. Next, at step 303, the local UMIAS module 125 transmits the LEPI to the UMIAS 101 where it is received by the UMIAS management module 160. After processing the LEPI, at step 304 the UMIAS management module 160 transmits the LEPI to the UMPI module 162 to identify the specific patient to which the LEPI (and image) pertain.

Upon receipt of the LEPI at the UMPI module 162, at step 305, the UMPI module 162 compares the received LEPI to information in the existing Universal Medical Patient Index. As discussed previously, LEPI typically includes patient identifying information (e.g., first name, last name, Social Security number, etc.) in addition to a LEPI number. Therefore, returning to fictional patient John Jones, at step 305, if the UMPI module 162 receives LEPI indicating the patient's first and last names are, respectively, JOHN and JONES, and the patient's LEPI number is 00552-JJ0839 for the given medical provider, the UMPI module 162 compares this information to the existing UMPI. If Mr. Jones has no existing UMPI Number, at step 306 the UMPI module 162 creates an UMPI Number associated to Mr. Jones, e.g., 684-JJX-000389, and stores his other patient identifying information. In the case that Mr. Jones already has an existing UMPI Number, at step 306 the UMPI module 162 retrieves the appropriate UMPI Number. After creating or retrieving the UMPI Number at step 306, the UMPI module 162 then transmits the UMPI Number to the UMIAS management module 160 at step 307, which subsequently transmits the UMPI Number to the edge device 124 at the hospital 110, at step 308.

Upon receipt of the UMPI Number at the edge device 124, at step 309, the local UMIAS module 125 of the edge device 124 associates the UMPI Number to the medical image. According to one embodiment, the UMPI Number is stored in the image's DICOM tag. Once the UMIAS module 125 associates the UMPI Number to the image, at step 310A, the edge device 124 transmits the medical image and associated UMPI Number, LEPI, and other image information back to the UMIAS 101. According to one embodiment, the system 101 can be configured such that the image and associated information are instantaneously sent to the UMIAS 101; however, the system 101 also can be configured such that the image and associated information are forwarded back to the UMIAS 101 after a predetermined delay (e.g., one week, six months, etc.). After receiving the image and associated information, the UMIAS module 160 then transmits the image and associated information to the universal archive 166 for global or universal storage, at step 311.

According to one embodiment, after associating the UMPI Number to the medical image, at step 310B the edge device 124 transmits the image with the associated UMPI Number, LEPI, and other image information to the local archive 128 for local storage. According to various aspects of the presently-disclosed embodiment, the local archive module, e.g., 130, can be configured with various medical image storage options. According to one aspect, the local archive 128 can be configured such that medical images created within the facility are stored purely offsite and in the centralized, hosted cloud environment, i.e., in the UMIAS 101. Alternatively, according to one aspect, the local archive 128 can be configured such that the medical images are locally cached for a predetermined period of time, e.g., six months, and then transferred to the UMIAS 101 for permanent archive storage. Further, according to one aspect, the local archive 128 can be configured for a hybrid storage model wherein the medical image and associated information are stored locally at the local archive 128 and at the UMIAS 101. As will be understood, according to one aspect, the images can be stored permanently in both the UMIAS 101 and the local archive 128, but the local archive 128 can be configured to store the images for any predetermined period of time (e.g., six months, one year, five years, etc.). As will be understood and appreciated, in addition to enabling the use of medical information and images across a plurality of provider systems and platforms, the redundancy storage provided by the UMIAS 101 provides disaster recovery in the chance the locally-stored image is lost.

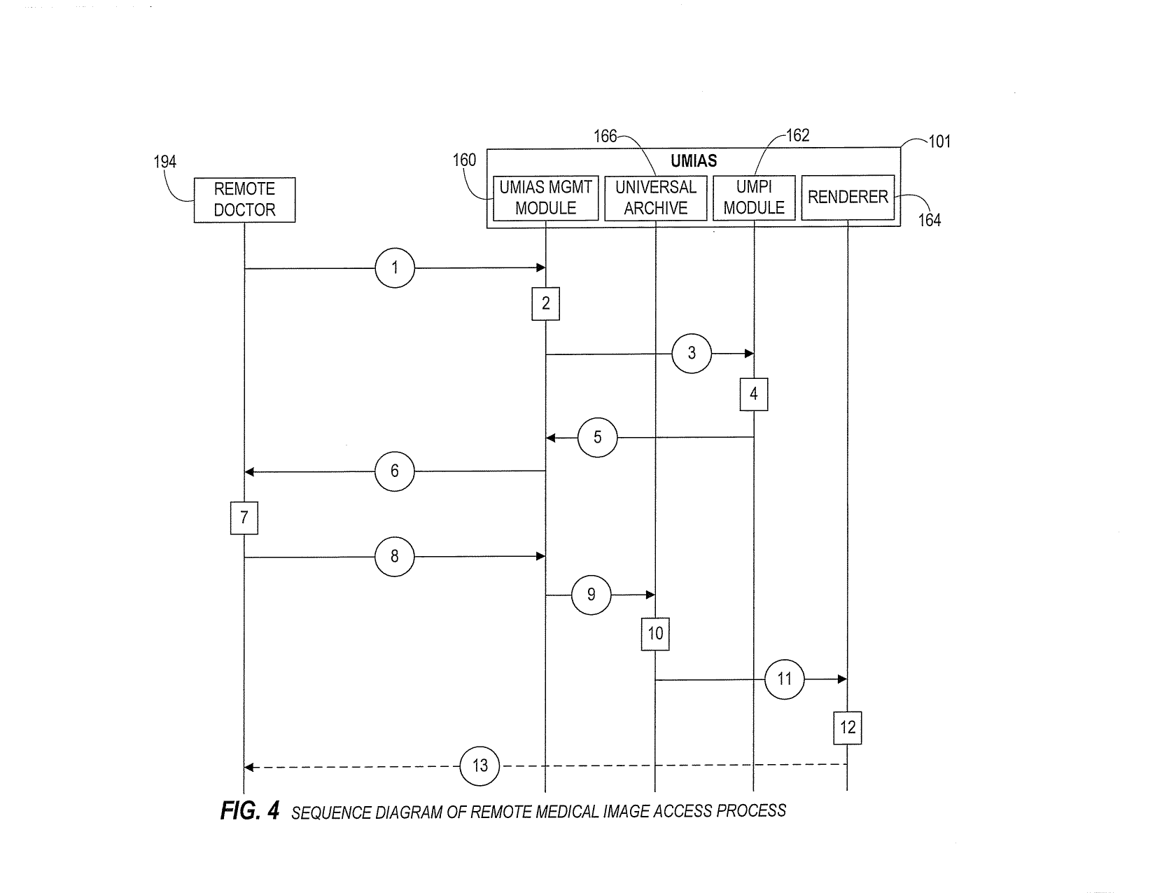

FIG. 4 is a sequence diagram illustrating an exemplary sequence of steps associated with remotely accessing medical information and images, according to one embodiment of the present disclosure. In one embodiment, a medical professional remotely accesses the UMIAS 101 to view a particular patient's medical image or images. In other embodiments, it could be patients or other patient representatives who remotely access the UMIAS 101 to view such information. As previously discussed and as will be understood and appreciated, such remote access as disclosed in the present embodiment allows medical providers flexibility and mobility in offering patient care as it eliminates the need to access a PACS located at a medical facility. Further, as described in relation to FIG. 2A, remote doctors are able to access a patient's medical information or images even in situations where the doctor has incomplete patient identifying information, according to one embodiment of the present disclosure.

Still referring to FIG. 4, at step 401, a doctor working remotely, e.g., vacationing doctor 194, requests a medical image via a UMIAS interface 192a running on a mobile device 190. The doctor's 194 request, which generally includes registered UMIAS user information in addition to relevant patient identifying information, is transmitted to the UMIAS 101 and received by the UMIAS management module 160. At step 402, the UMIAS management module 160 confirms the user's registered login information. As will be understood and appreciated, in one embodiment, only registered users are able to access the UMIAS 101, which aids is protecting patient privacy. At step 403, after confirming the user's login information, the UMIAS management module 160 transmits the received patient identifying information (i.e., LEPI) to the UMPI module 162.

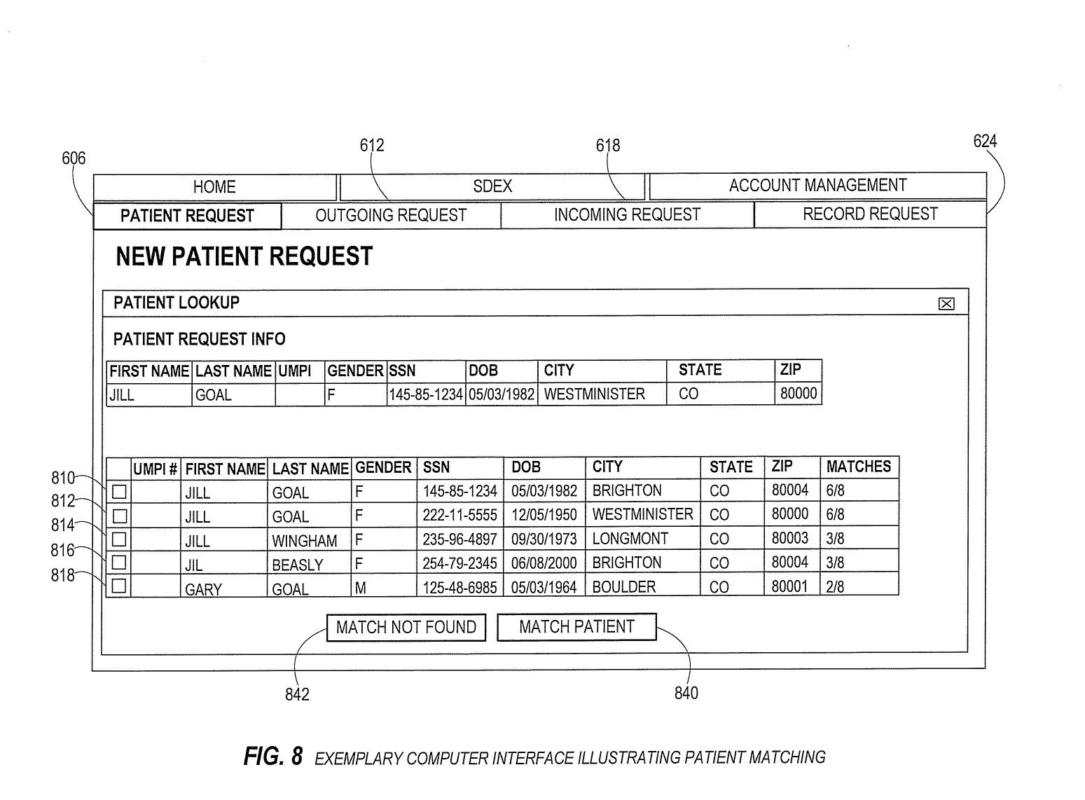

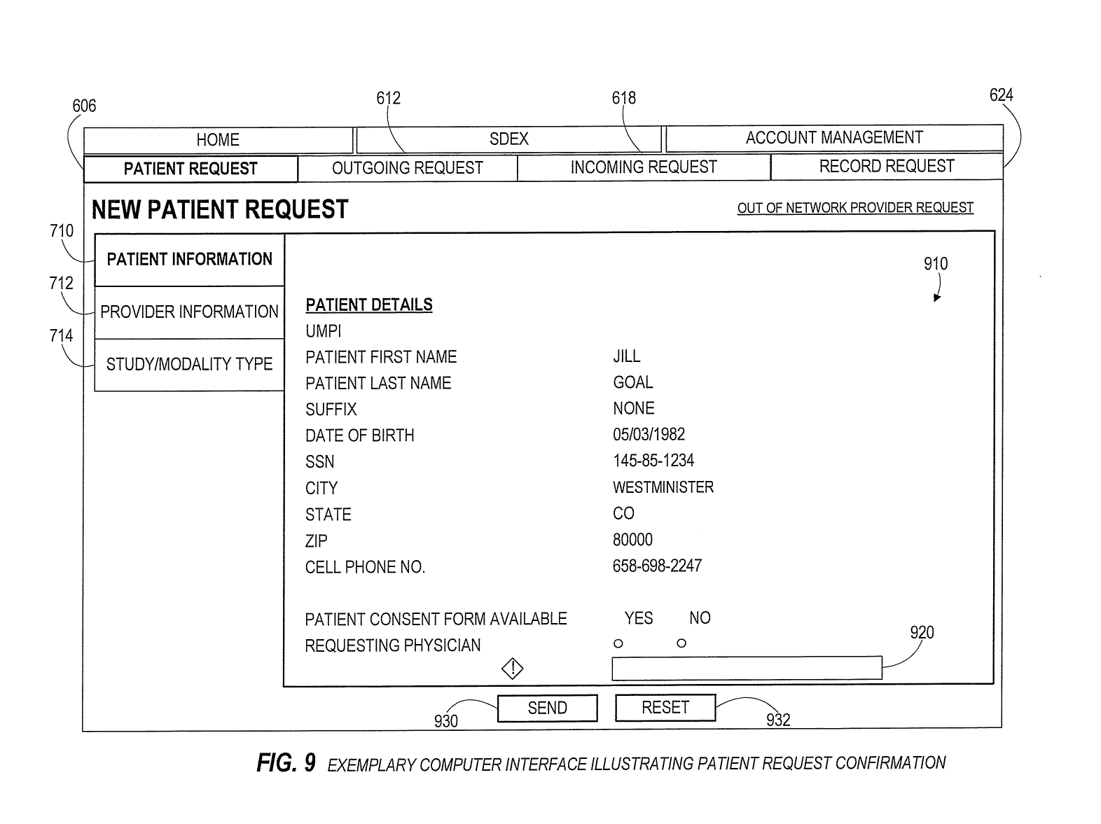

The UMPI module 162 then compares any received patient identifying information, which may include any combination of LEPI, LEPI number, and/or UMPI NUMBER, to the existing UMPI, at step 404. The vacationing doctor 194 making the request may have a great deal of information or very little patient identifying information. In the case of fictional patient John Jones, it is possible the doctor 194 will know nothing about the patient aside from his first and last name and the type of medical image the doctor 194 is expecting to review. At step 404, the UMPI module 162 compares any received information to the existing UMPI Identifiers to determine potential matches for the doctor's 194 request. After determining potential matches, at step 405, the UMPI module 162 transmits the potential matches to the UMIAS management module 160, which then transmits them to the doctor 194 at step 406. After the doctor 194 reviews and confirms the proper patient from the potential matches at step 407, the UMIAS interface 192a is used to transmit the proper patient confirmation to the UMIAS management module 160, at step 408. (Additional information relating to the potential matches and the confirmation of the proper patient will be discussed in relation to FIGS. 8-9.)

Upon receiving the proper patient confirmation, at step 409, the UMIAS management module 160 transmits the confirmation, which includes the associated UMPI Number, to the universal archive 166. Subsequently, at step 410, the universal archive 166 retrieves the requested medical image(s) file(s) based on the UMPI Number and then transmits the digital file(s) to the renderer 164 at step 411. According to one aspect, when multiple images are requested, multiple providers may be responsible for each respective image. Once the digital image file is received, at step 412 the renderer 164 renders the medical image and, at step 413 makes it available so that it can be viewed by the doctor 194 via the UMIAS interface 192a running on the mobile device 190.

According to an alternate embodiment (not illustrated), once the universal archive retrieves the digital file of the medical image, it then transmits digital file to the UMIAS management module 160 for delivery to the doctor 194 so that the image file can be rendered via an application running on the mobile device 190. Preferably, however, the image is rendered at the UMIAS 101 and displayed to the remote doctor 194 via the remote UMIAS software (e.g., UMIAS management module 160). As will be understood and appreciated, this avoids sending lard, sensitive files from one system to another (i.e., the files are maintained and rendered locally at the UMIAS 101).

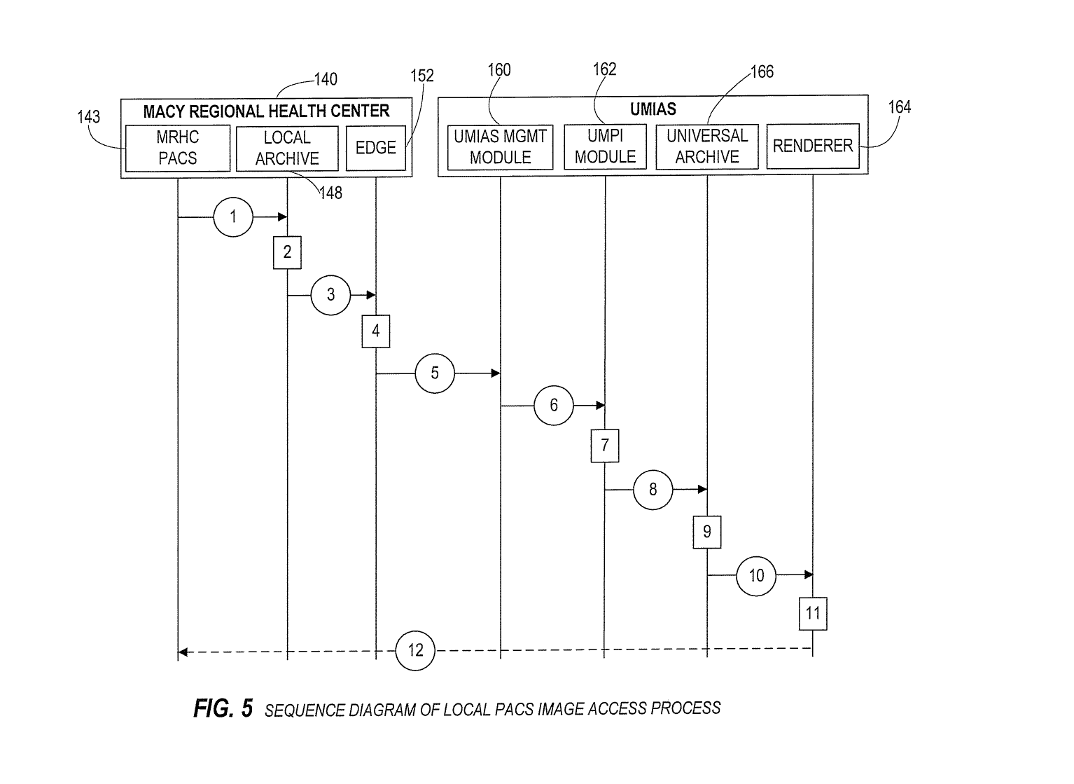

FIG. 5 is a sequence diagram illustrating the sequence of steps associated with a medical professional utilizing a local PACS, e.g., MRHC PACS 143, to request a medical image from the UMIAS 101, according to one embodiment. At step 501, the PACS user requests a medical image based on any available LEPI and/or a LEPI number, such request being transmitted to the local archive 146. At step 502, the local archive 146 determines whether the requested image currently is stored locally. This may be because the image that is being requested was generated at a different medical facility, or because the particular local archive does not maintain a local image storage (i.e., the facility only utilizes cloud storage), etc. Upon determining the image is not locally stored, at step 503 the local archive 146 transmits the request with the corresponding patient identifying information (i.e., LEPI and/or LEPI number) to the edge device 152, which in turn transmits the request to the UMIAS 101 where it is received by the UMIAS management module 160, at step 505.

Upon receipt of the image request, at step 506, the UMIAS management module 160 transmits the request to the UMPI module 162. Then, at step 507, and as discussed in relation to FIG. 3, the UMPI module 162 compares the received patient identifying information (LEPI and/or LEPI number) to the existing Universal Medical Patient Index to determine the patient's UMPI Number. Once the UMPI module 162 determines the proper UMPI Number, at step 508, the UMPI module 162 transmits the request with the associated UMPI Number to the universal archive 166, which then retrieves the requested image based on the UMPI number at step 509. Once the proper medical image file is retrieved, at step 510 the universal archive 166 transmits the file to the renderer 164, which then renders the image (at step 511) and makes it available to the PACS user who made the initial request (at step 512).

It is, of course, possible that a medical provider's request (at step 501) will include a proper UMPI Number. According to one embodiment, when the UMIAS module 160 receives a request containing an UMPI Number, it skips step 507 and transmits the request directly to the universal archive 166, which then retrieves the proper image(s) at step 509 and proceeds as described above.

FIG. 6 is an exemplary embodiment of a dashboard (or home screen) 600 of a computer interface for interacting with an embodiment of the UMIAS 101. As discussed previously, access to the UMIAS 101 via a UMIAS interface (e.g., 192a or 192b) is generally controlled via registered user information such as a user name and password, as will be understood by one of ordinary skill in the art. Once a user (e.g., medical provider, doctor, representative of a hospital or medical provider, patient, etc.) successfully accesses the UMIAS 101, according to one embodiment, the dashboard 600 presents various options for interacting with the system 101.

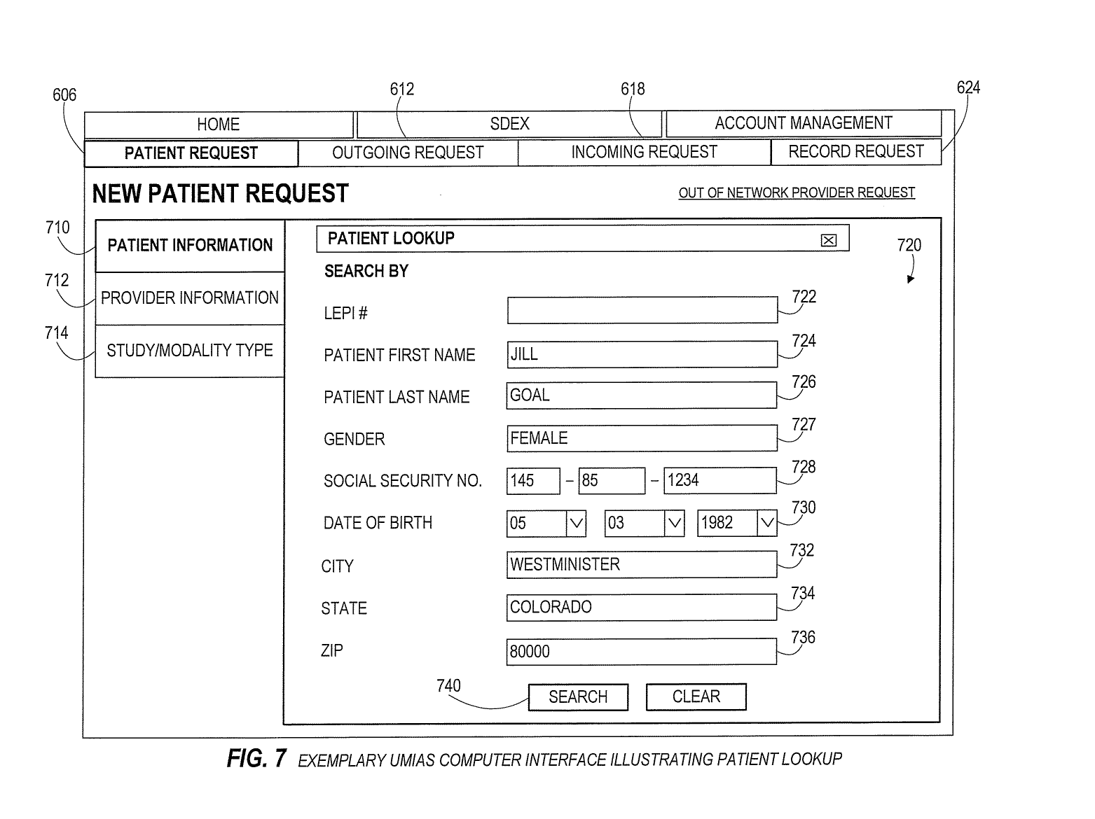

According to the embodiment shown in FIG. 6, the user is presented with a selectable tab for requesting patient medical images 606. According to one embodiment, a medical provider utilizes the UMIAS dashboard 600 to request medical information or images from within the network that have been generated by other providers. (Additional details relating to requesting information relating to a particular patient will be discussed in relation to FIGS. 7-10). Additionally, as shown in the FIG. 6 embodiment, the dashboard presents the user with a register of recently submitted requests (i.e., Outgoing Requests 640). As shown in FIG. 6, the particular provider has recently requested information relating to fictional patients Jim Davis 642, Peter Tyler 644, Beth Rogan 646, and Bethany Harris 648. According to one aspect, the dashboard 600 also displays when the requests were made and which provider originally captured the image. As shown, the dashboard 600 also provides a tab for managing outgoing requests 612, which can be utilized if a user needs to amend a previously-sent request. For example, if in reviewing the outgoing requests 640 information, the provider determines that request 644 relating to Beth Rogan should have been directed to Macy Regional Medical Center, the request can be amended by selecting tab 612.

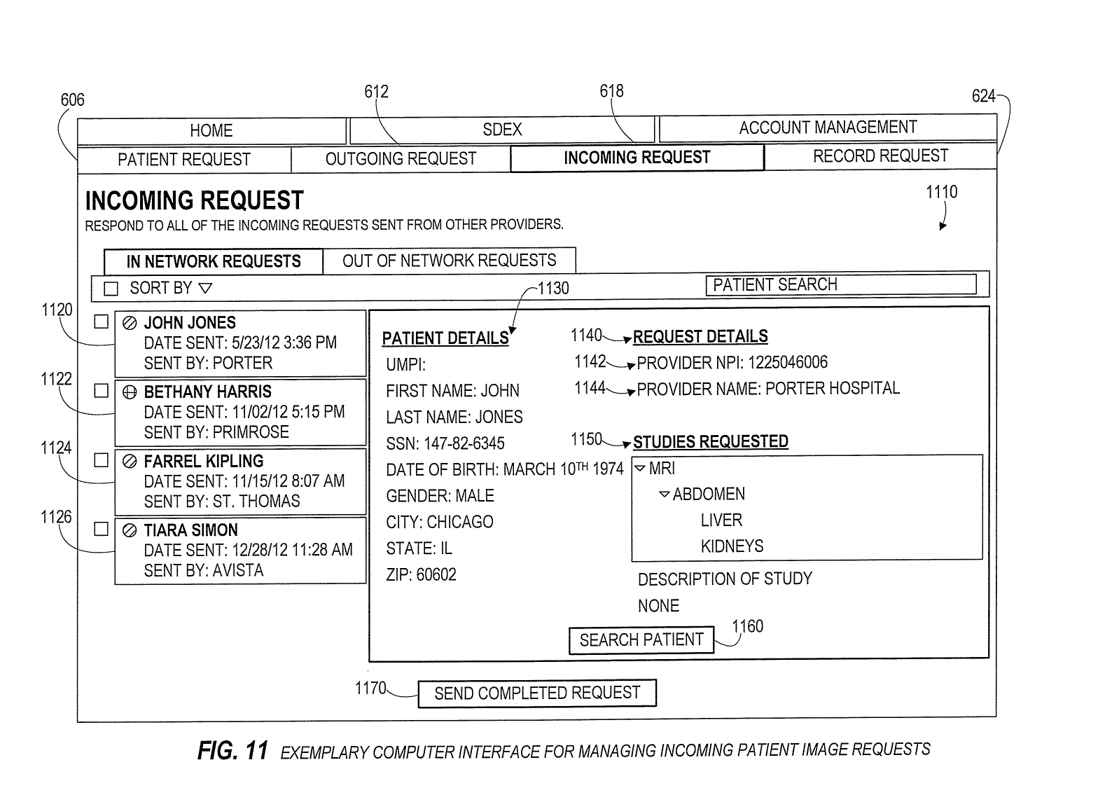

Continuing with the dashboard 600 shown in FIG. 6, a user is presented with a tab for responding to incoming requests 618 or viewing incoming requests 624, which will be discussed further in relation to FIG. 11. According to one embodiment, certain patient images may be stored in a local archive (e.g., 128), in which case a representative of the provider will handle requests for such images directly. In an alternate embodiment, the provider responsible for a particular image stored in the universal archive must approve a request before the image is released to the requesting medical provider. In either case, according to the FIG. 6 embodiment, the system administrator can utilize tabs 618 and 624 to manage such requests. Additionally, as shown, the dashboard presents the user with a list of recent incoming requests 630. For example, as shown in FIG. 6, the particular provider has received requests relating to Farrel Kipling 632, Tiara Simon 634, Jill Goal 636, and Bethany Harris 638. As noted, in one embodiment, the system administrator can respond to these requests by selecting tab 618 and can view additional requests with tab 624.

As previously discussed, the UMIAS 101 allows various medical providers in various locations to securely store and exchange patient information and medical images, and these tasks are facilitated by the dashboard 600. As such, the UMIAS 101 generally processes a UMIAS user's request for a medical image or patient information (as discussed in relation to FIGS. 4 and 5). As shown in the FIG. 7 embodiment, after selecting the Make New Patient Request tab 606 on the dashboard 600, the UMIAS interface presents the user with a patient request interface 700. Upon selecting the Patient Information tab 710, the user is presented with the Patient Lookup interface 720, into which the user enters any available patient identifying information (i.e., LEPI) or a LEPI number. According to one embodiment, the system may also allow the user to enter a patient's UMPI Number if it is known. As shown in FIG. 7, the user has entered “JILL” and “GOAL” into fields 724 and 726, respectively. Further, the user has entered the patient's gender, Social Security number, date of birth, city and state of residence, and zip code into the respective fields, i.e., 727, 728, 730, 732, 734, and 736, all of which represent the entirety of the LEPI for patient (i.e., Jill Goal) known to the user. According to one embodiment, the local edge device (e.g., 124) transmits the request with the relevant patient identifying information (LEPI) to the UMIAS 101.

In the example embodiment shown in FIG. 8, the UMIAS 101 returns various options that share similarities with the patient identifying information provided in relation to FIG. 7 (i.e., JILL GOAL). As will be understood by one of ordinary skill in the art, the process involved with determining potential matches for the user's request is similar to the process described in relation to FIG. 3. As shown, the UMIAS 101 provides information relating to various medical patients whose identifying information is similar to that submitted in the patient request, which are shown juxtaposed to the provided LEPI (i.e., patient request information) provided in the patient request.

In the example shown in FIG. 8, the UMIAS 101 has provided five potential matches to the patient request information. The first potential match 810 shares six data items of LEPI with the provided patient request (i.e., first name, last name, gender, Social Security number, date of birth, and state). The only non-matching criteria are city and zip code. Since the first potential match 810 matches six of the eight pieces of LEPI, as indicated in the matches column 830, there is a strong possibility that the first potential match 810 is the patient sought with the patient request. This possibility is strengthened because the other potential matches share an even lower percentage of LEPI matches with the patent request. The second potential match 812 does share the same first and last name, gender, city, state, and zip as the requested patient, and accordingly, the matches column 830 shows six of eight matches. Significantly, however, the Social Security number and date of birth are different from that of the requested patient. As further shown, potential matches 814, 816, and 818 share three, four, and two matches with the requested patient, respectively, as shown in the matches column 830.

As will be understood and appreciated, it is not uncommon for patients to change addresses, in which case certain pieces of LEPI, such as city and zip code, will change but may not be updated in a local archive (e.g., 128) or the universal archive 166. In such circumstances, more permanent pieces of LEPI, such as Social Security number and date of birth, are even more useful for determining whether a potential match corresponds to a requested patient. According to one embodiment, and as shown in FIG. 8, the UMIAS ranks potential matches not only according to the number of matched pieces of LEPI, but also according to whether a potential match's more permanent pieces of LEPI (i.e., Social Security number and date of birth) match those of the requested patient. As discussed in relation to FIG. 2B), according to certain aspects, the patient identifying algorithm used by the UMPI module 162 allocates more weight to particular pieces of patient identifying information that are more permanent, such as Social Security number and date of birth. Therefore, according to one embodiment, since both the Social Security number and date of birth match those of the requested patient, there is a stronger possibility that the first potential match 810 corresponds to the requested patient than, for example, the second potential match 812, which also matches six of eight criteria. As such, potential match 810 is displayed as the first potential match. In one unshown embodiment, instead of displaying a plurality of potential matches to the user, the UMIAS 101 determines the most likely match to the requested patient and presents that potential match to the user. In such an embodiment, although potential matches 810 and 812 both matched six of eight criteria, the UMIAS 101 would select potential match 810 to present to the user because it matched date of birth and Social Security number.

According to the embodiment shown in FIG. 9, after the user selects the Match Patient tab 840 shown in FIG. 8 to confirm a potential patient that matches the requested patient, the UMIAS 101 presents the user with a confirmation screen 900 showing all patient details 910 relating to the requested/confirmed patient. As will be understood and appreciated, this screen allows the user a second opportunity to confirm that the appropriate patient has been selected, and also shows additional information relating to the patient to the requester/user. According to one embodiment, after receiving the confirmation, the UMIAS maps the information relating to the patient request (i.e., LEPI) to the UMPI Number associated with the appropriate patient. Further, according to the embodiment shown in FIG. 9, the user is provided the opportunity to enter the name of the requesting physician into the Requesting Physician box 920. This allows the UMIAS 101 to track requests for patient information and medical images to better protect patient privacy. After reviewing the patient details 910, according to one embodiment, the user then confirms the request by selecting the Send tab 930.

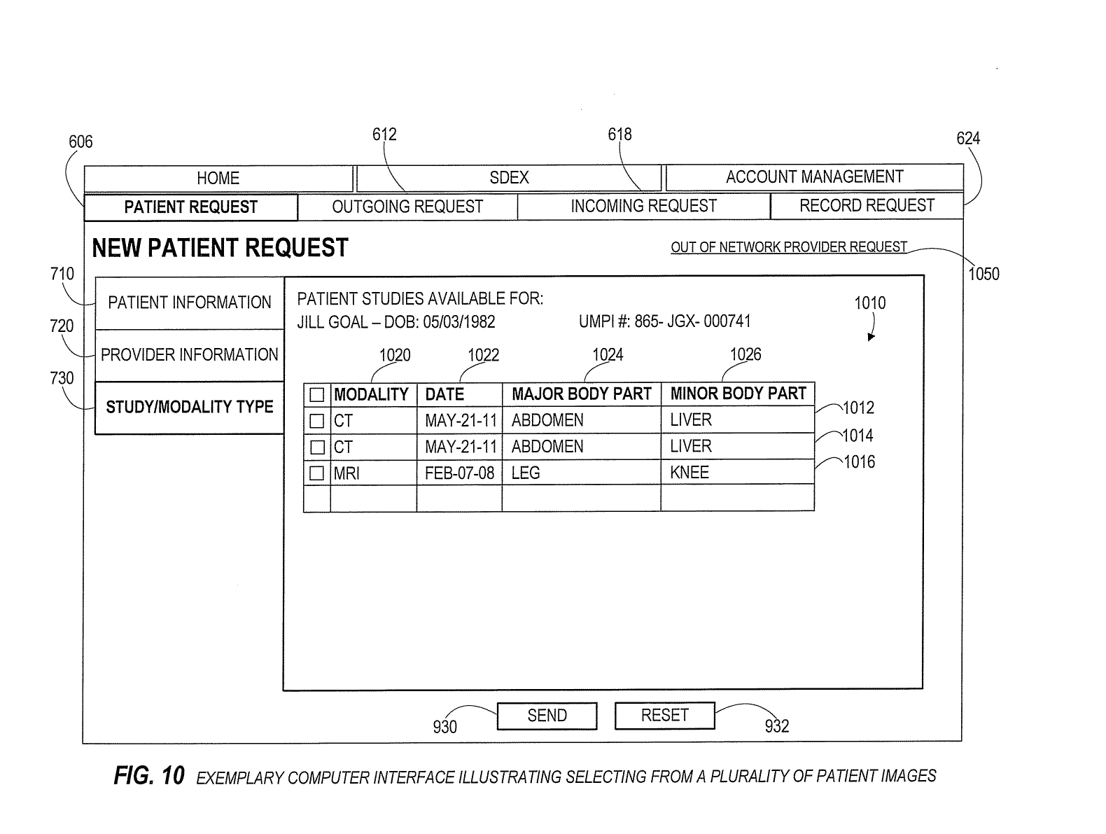

After confirming the request as discussed in relation to FIG. 9, the user can then select the Study/Modality Type tab 714. According to one embodiment, by selecting tab 714, the user is able to view all patient studies available in the UMIAS 101 for the requested patient, i.e., Jill Goal, as shown in the FIG. 10 interface. As shown in the available studies box 1010, fictional patient Jill Goal has three studies/images available: a liver CT scan 1012; an appendix CT scan 1014; and a knee MRI 1016. As shown, each image is designated by modality type 1020, the date the image was captured 1022, and both the major body part 1024 and minor body party 1026 captured in the image. As will be understood and appreciated, such information allows a user or medical provider to narrow down the images to be selected. For example, a medical provider interested in a patient's medical history dating back only to 2011 can exclude Jill Goal's MRI from 2008. According to one embodiment, after choosing the appropriate studies, the user then submits the request by selecting the send button 930, at which time the images are made available to the user as discussed in relation to FIGS. 4 and 5. Alternatively, in one embodiment, the request is routed to the provider at which the image was originally captured, and the request is approved by a representative of that provider. Subsequent to this approval, the requested image(s) is made available to the user. As will be understood and appreciated, this additional approval process further protects patient privacy.

According to one embodiment, as opposed to being presented with the available studies box 1010 shown in FIG. 10, the system may be configured to present the user with various drop-down menus, which correspond to various types of modalities (e.g., MRI, CT, mammogram, ultrasound, etc.), as well as both major and minor body parts. Additionally, according to one aspect, the user is provided with the opportunity to enter a timeframe during which each selected image was taken. Further, according to one aspect, the user is provided with space to enter an additional description regarding the requested medial image. As will be understood and appreciated, such a configuration further protects patient privacy by requiring a user to request a particular image as opposed to unnecessarily displaying all of a patient's stored images to the user.

In some cases, the available studies box 1010 may not show the particular study in which the user is interested. In such cases, it is possible that the provider responsible for the particular image is not a member of the UMIAS network, and therefore the image is not stored in the universal archive 166 or an accessible local archive, e.g., 128 or 146. According to one embodiment, the user can choose to send the responsible provider an out-of-network request by selecting the Out of Network Provider Request tab 1050. According to one aspect, selecting tab 1050 presents the user with a form, which includes the relevant patient information, that can be printed and sent to the out-of-network provider via mail or fax. According to another aspect, the out-of-network request can be sent electronically (e.g., via email, text message, online post, etc.), as will be understood by one of ordinary skill in the art.

As previously discussed, typically, the majority of patient information and medical images in the UMIAS network will be stored in a universal archive 166. There are instances, however, in which in addition to being stored in the universal archive 166, providers can configure their local archive settings such that medical images are cached locally for a predetermined period of time (e.g., six months) after being associated to an UMPI number, as discussed in relation to FIG. 3. In such circumstances and according to one embodiment, the UMIAS management module 160 may transmit a provider's request for a particular medical image to the facility where the locally cached image is stored. Additionally, in one embodiment as discussed above, the system can be configured such that a request for a particular image must be approved by a representative of the provider that created the image. FIG. 11 displays an embodiment of a user interface for providers to manage such requests (i.e., to respond to requests for locally stored images or to approve requests for images stored in the universal archive 166). As shown, after logging into the system and selecting the Respond to Incoming Requests tab 618, the user is presented with the incoming request interface 1110, which includes information relating to various requests directed to the provider.

As shown in FIG. 11, the provider (or system administrator) has received four requests. Each of the four requests, i.e., 1120, 1122, 1124, and 1126, include the name of the patient, the date and time of the request, and the name of the requesting provider. As discussed, these requests could be for images that are locally stored. Alternatively, the request may be for approval of another provider's request for a particular image. After selecting request one 1120, for fictional patient John Jones, the system administrator is presented with additional patient details 1130 relating to John Jones, which include various pieces of LEPI as well as an UMPI Number 1132. According to one embodiment, the user requesting the image provides the appropriate UMPI Number. According to an alternate embodiment, the UMIAS 101 provides the appropriate UMPI Number after receiving the request and before forwarding the request to the correct provider. Further, according to the embodiment shown in FIG. 11, additional request details 1140 are displayed. These additional request details 1140 not only include the provider name 1144, but also the provider NPI 1142, which is a universal provider identifier as will be understood by one of ordinary skill in the art. The request details 1140 also include studies requested information 1150, which typically identifies the particular requested modality as well as the major and minor body part included in the image. According to one embodiment, the interface includes a Search Patient Tab 1160, which generally allows the administrator to search the local archive for the requested images, and a send Completed Request Tab 1170, which typically allows the administrator to attach copies of the files of the requested image and electronically transmit them back to the requester, as will be understood by one of ordinary skill in the art. In another embodiment, the provider simply approves the request (i.e., the provider does not have to search the local archive for the requested images as it is stored in the universal archive 166), and the UMIAS 101 locates and provides the image to the requester once approved.

As presented above, aspects of the present disclosure generally relate to systems and methods for managing, securely storing, and exchanging patient information and medical images across a plurality of medical facilities and providers. In one embodiment, the UMIAS 101 allows various medical providers in various physical locations to securely store and exchange patient information and medical images. Instead of a complex mesh wherein, for example, a hospital has separate protocols and communications links in place for exchanging information and images with other hospitals and respective providers, who in turn have their own separate protocols and communications links in place for doing the same, the UMIAS 101 provides a streamlined, unified, universal system that is easily accessible to registered users. According to one aspect, the UMIAS 101 allows providers to request and view a particular patient's entire medical profile, which may include various medical images from various providers as well as myriad other items of medical information, from a centralized archive as opposed to requesting the information from each respective provider.

Further, as discussed, according to one embodiment, the UMIAS 101 maintains a Universal Medical Patient Index (“UMPI”) in an UMPI module 162, which collects and unifies local electronic patient information (“LEPI”) such as patient name, date of birth, Social Security number, etc., as well as any LEPI numbers or identifiers (i.e., provider-assigned patient identification numbers that serve to protect patient identity), thus facilitating patient information requests. Further still, according to one embodiment, the UMIAS 101 assigns each patient a particular UMPI Number (or UMPI Identifier) that serves as a universal identifier for a particular patient, which is appended to all incoming medical images and can be used by all facilities to identify a information relating to a given patient, share medical images for given patients across facilities, and perform a host of other cloud-based or virtual functions.

Systems and methods disclosed herein may be implemented in digital electronic circuitry, in computer hardware, firmware, software, or in combinations of them. Apparatus of the claimed invention can be implemented in a computer program product tangibly embodied in a machine-readable storage device for execution by a programmable processor. Method steps according to the claimed invention can be performed by a programmable processor executing a program of instructions to perform functions of the claimed invention by operating based on input data, and by generating output data. The claimed invention may be implemented in one or several computer programs that are executable in a programmable system, which includes at least one programmable processor coupled to receive data from, and transmit data to, a storage system, at least one input device, and at least one output device, respectively. Computer programs may be implemented in a high-level or object-oriented programming language, and/or in assembly or machine code. The language or code can be a compiled or interpreted language or code. Processors may include general and special purpose microprocessors. A processor receives instructions and data from memories. Storage devices suitable for tangibly embodying computer program instructions and data include forms of non-volatile memory, including by way of example, semiconductor memory devices, such as EPROM, EEPROM, and flash memory devices; magnetic disks such as internal hard disks and removable disks; magneto-optical disks; and Compact Disk. Any of the foregoing can be supplemented by or incorporated in ASICs (application-specific integrated circuits).

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope. Accordingly, the scope of the present inventions is defined by the appended claims rather than the foregoing description and the exemplary embodiments described therein.

What is claimed is:

1. In a universal medical information archive system (UMIAS), wherein the UMIAS is operatively connected to a plurality of local medical information archiving systems operated by a plurality of medical providers, and wherein the UMIAS comprises a management computer system and one or more databases, a method for managing medical patient information, comprising the steps of:
receiving at the UMIAS patient identifying information relating to a particular medical patient from a particular medical provider, wherein the received patient identifying information is associated with patient diagnostic information relating to the particular medical patient and maintained at a local medical information archiving system operated by the particular medical provider;
comparing via the UMIAS the received patient identifying information relating to the particular medical patient to a plurality of previously received items of patient identifying information relating to a plurality of medical patients stored in a UMIAS database, wherein the plurality of items of previously received patient identifying information was received from a plurality of medical providers;
identifying via the UMIAS a universal medical patient index (UMPI) number associated with the particular medical patient based on the comparison of the received patient identifying information to the plurality of previously received items of patient identifying information, wherein each UMPI number corresponds to a respective medical patient and is associated with a plurality of items of patient identifying information relating to each respective medical patient;
associating via the UMIAS the identified UMPI number associated with the particular medical patient with the patient identifying information relating to the particular medical patient in the UMIAS database;
transmitting the identified UMPI number associated with the particular medical patient from the UMIAS to the local medical information archiving system operated by the particular medical provider for associating the identified UMPI number with the patient diagnostic information;
receiving at the UMIAS the patient diagnostic information relating to the particular medical patient and associated UMPI number; and
storing the received patient diagnostic information relating to the particular medical patient and associated UMPI number in the UMIAS database,
whereby the received patient diagnostic information relating to the particular medical patient is available to the plurality of medical providers operating the plurality of local medical information archiving systems operatively connected to the UMIAS.

2. The method of claim 1, wherein the received patient identifying information is selected from the group comprising: first name, last name, Social Security number, date of birth, address, city, state, zip code, local electronic patient information (LEPI) number.

3. The method of claim 1, wherein the received patient diagnostic information relating to the particular medical patient comprises one or more medical images.

4. The method of claim 1, wherein the step of identifying a universal medical patient index (UMPI) number associated with the particular medical patient further comprises the steps of:
determining whether a match exists between the received patient identifying information relating to the particular medical patient and the plurality of previously received items of patient identifying information relating to a plurality of medical patients; and
upon determination that no match exists, generating via the UMIAS a universal medical patient index (UMPI) number for the particular medical patient.

5. The method of claim 1, wherein the step of associating the identified UMPI number associated with the particular medical patient with the patient diagnostic information further comprises appending the identified UPMI number to a DICOM tag associated with the patient diagnostic information.

6. The method of claim 5, wherein the identified UMPI number is appended to a DICOM tag associated with the patient diagnostic information via the UMIAS.

7. The method of claim 1, wherein the steps of claim 1 are performed within the environment of a health information exchange (HIE).

8. The method of claim 1, wherein the plurality of medical providers are located in geographically disparate regions.

9. The method of claim 1, wherein the local medical information archiving systems of the plurality of medical providers are operated independently.

10. The method of claim 1, wherein the step of receiving patient identifying information relating to a particular medical patient further comprises the step of extracting the patient identifying information relating to the particular medical patient from metadata associated with the patient diagnostic information relating to the particular medical patient.

11. The method of claim 10, wherein a DICOM tag associated with the patient diagnostic information relating to the particular medical patient comprises the metadata from which the patient identifying information relating to the particular medical patient is extracted.

12. The method of claim 1, wherein the patient diagnostic information conforms to one or more existing DICOM protocols.

13. A universal medical information archive system (UMIAS) for managing medical patient information, wherein the UMIAS is in operative communication with a plurality of local medical information archiving systems operated by a plurality of medical providers, comprising:
a database for storing information utilized by the UMIAS, comprising: (i) a plurality of items of patient identifying information relating to a plurality of medical patients, wherein the plurality of items of patient identifying information was received from a plurality of medical providers; (ii) a plurality of universal medical patient index (UMPI) numbers, wherein each UMPI number corresponds to a respective medical patient and is associated with a plurality of items of patient identifying information relating to each respective medical patient; and (iii) patient diagnostic information relating to a particular medical patient and associated with the UMPI number corresponding to the particular medical patient;
a UMIAS management computer module for performing functions of the UMIAS, comprising: (i) receiving particular patient identifying information relating to a particular medical patient from a particular medical provider, wherein the received particular patient identifying information is associated with patient diagnostic information relating to the particular medical patient and maintained at a local medical information archiving system operated by the particular medical provider; (ii) comparing the received particular patient identifying information relating to the particular medical patient to the plurality of items of patient identifying information relating to a plurality of medical patients to identify an UMPI number associated with the particular medical patient based on the comparison of the received particular patient identifying information to the plurality of items of patient identifying information; (iii) associating the identified UMPI number associated with the particular medical patient to the particular patient identifying information relating to the particular medical patient in the database; and (iv) receiving patient diagnostic information relating to the particular medical patient; and
a plurality of edge devices in operative communication with the plurality of local medical information archiving systems operated by the plurality of medical providers for managing communication between the UMIAS management computer module and the plurality of local medical information archiving systems, the plurality of edge devices further operative for receiving patient diagnostic information from the plurality of local medical information archiving systems and associating UMPI numbers with the received patient diagnostic information.

14. The system of claim 13, wherein the patient identifying information is selected from the group comprising: first name, last name, Social Security number, date of birth, address, city, state, zip code, local electronic patient information (LEPI) number.

15. The system of claim 13, wherein the patient diagnostic information relating to the particular medical patient comprises one or more medical images.

16. The system of claim 13, wherein the system operates within the environment of a health information exchange (HIE).

17. The system of claim 13, wherein the plurality of medical providers are located in geographically disparate regions.

18. The system of claim 13, wherein the local medical information archiving systems of the plurality of medical providers are operated independently.

19. The system of claim 13, wherein the patient diagnostic information conforms to one or more existing DICOM protocols.

20. A method for providing remote access to medical images, comprising the steps of:
receiving at a universal medical information archive system (UMIAS) a request for one or more medical images relating to a particular patient, wherein the request includes a plurality of items of patient identifying information relating to the particular patient;
extracting from the request via the UMIAS the plurality of items of patient identifying information relating to the particular patient;
identifying a universal medical patient index (UMPI) number associated with the particular patient by comparing the extracted plurality of items of patient identifying information relating to the particular patient to a plurality of prestored items of patient identifying information relating to a plurality of patients in a first UMIAS database, wherein each UMPI number corresponds to a respective patient and is associated with a plurality of items of patient identifying information relating to each respective patient;
retrieving from a second database one or more electronic data files corresponding to the one or more requested medical images relating to the particular patient based on the identified UMPI number corresponding to the particular patient; and
rendering the one or more electronic data files via the UMIAS to generate one or more viewable representations of the one or more requested medical images,
whereby the viewable representation of the one or more requested medical images is made available for viewing.

21. The method of claim 20, wherein the request for one or more medical images relating to a particular patient is received from a registered user of the UMIAS.

22. The method of claim 21, wherein the registered user must provide log-in information prior to accessing the UMIAS.

23. The method of claim 21, wherein a registered user is selected from the group comprising: doctor, medical provider staff member, patient, patient's authorized representative.

24. The method of claim 20, wherein patient identifying information is selected from the group comprising: first name, last name, Social Security number, date of birth, address, city, state, zip code, local electronic patient information (LEPI) number.

25. In a universal medical information archive system (UMIAS), wherein the UMIAS is operatively connected to a plurality of local medical information archiving systems operated by a plurality of medical providers, and wherein the UMIAS comprises a management computer system and one or more databases, a method for managing medical patient information, comprising the steps of:
receiving at the UMIAS patient identifying information and patient diagnostic information relating to a particular medical patient from a particular medical provider;
comparing via the UMIAS the received patient identifying information relating to the particular medical patient to previously received patient identifying information relating to a plurality of medical patients stored in a UMIAS database;
identifying via the UMIAS a universal medical patient index (UMPI) number associated with the particular medical patient based on the comparison of the received patient identifying information to the previously received patient identifying information, wherein each UMPI number is unique to each respective medical patient; and
associating via the UMIAS the identified UMPI number associated with the particular medical patient to the patient diagnostic information relating to the particular medical patient in the UMIAS database,
whereby the patient diagnostic information relating to the particular medical patient is available to the plurality of medical providers operating the plurality of local medical information archiving systems operatively connected to the UMIAS.

26. The method of claim 25, further comprising the step of transmitting the identified UMPI number associated with the particular medical patient to the local medical information archiving system operated by the particular medical provider.

27. The method of claim 25, wherein the received patient identifying information and patient diagnostic information relating to the particular medical patient are maintained at a local medical information archiving system operated by the particular medical provider

28. The method of claim 25, wherein the previously received patient identifying information was received from a plurality of medical providers.
